(19) United States
(12) Patent Application Publication
(10) Pub. No.: US 2026/0070466 A1
(43) Pub. Date: Mar. 12, 2026

(54) METHOD AND SYSTEM FOR CONTROLLING VEHICLE-MOUNTED ELECTRICAL DEVICE

(71) Applicant: SHENZHEN HUAPTEC CO., LTD, SHENZHEN (CN)

(72) Inventors: YANWEI WANG, SHENZHEN (CN); SONGLIN ZHOU, SHENZHEN (CN); YANLIN XIE, SHENZHEN (CN)

(21) Appl. No.: 18/914,074

(22) Filed: Oct. 12, 2024

(30) Foreign Application Priority Data
Sep. 11, 2024 (CN) 202411273975.1

(51) Int. Cl. B60L 58/12; H04B 1/04

(52) U.S. Cl. CPC B60L 58/12; B60L 2250/10; H04B 1/0458; H04B 1/0483

(57) ABSTRACT

A method and system for controlling a vehicle-mounted electrical device, a computer-readable storage medium, and a computer device are provided. The method includes: acquiring, by a detection and control circuit, a real-time voltage of a power source and determining, by the detection and control circuit, a type of the power source through comparing the real-time voltage with a criterion voltage, wherein the detection and control circuit acquires the real-time voltage in a wired manner or in a wireless manner; invoking a charge control range corresponding to the type of the power source, and determining whether an alarm is required and whether to control a power supply to an electrical apparatus based on a relationship between the charge control range and a real-time remaining charge of the power source.

### FIELD

The present disclosure relates to the field of vehicular control technology, particularly to a method and system for controlling a vehicle-mounted electrical device and capable of regulating power consumption, protecting a power source, and providing alarms.

### BACKGROUND

In the current market, vehicle-mounted signal boosters or other electrical devices are mostly powered by a vehicle battery. The vehicle-mounted signal booster is equipped with an exterior antenna for receiving downlink signals from external facilities such as base stations and satellites, which are then transmitted to a host of the vehicle-mounted signal booster. The host amplifies the downlink signals and transmits the amplified signals to an interior antenna, which, in turn, covers the amplified base station signals to terminal devices such as mobile phones inside the vehicle. The interior antenna of the vehicle-mounted signal booster receives uplink signals from the terminal devices inside the vehicle and transmits the uplink signals to the host of the vehicle-mounted signal booster for amplification. The host then transmits the amplified uplink signals to the exterior antenna, which relays the amplified uplink signals to base stations, satellites, and other facilities. Through the approach described above, the uplink and downlink signals are enhanced, allowing users to regain good signals in poor signal vehicular environments.

This type of booster or other electrical devices typically cannot detect charge of the vehicle battery and automatically adjust power consumption thereof. In scenarios such as when the vehicle engine is off or the battery power is insufficient, it may lead to battery depletion, resulting in insufficient power supply to the vehicle or even difficult to restart, causing poor user experience and, in some cases, economic losses (e.g., paying for assistance to start the vehicle) or even danger (vehicle failing to start in critical moments). Moreover, the power consumption of existing vehicular signal boosters is difficult to regulate, causing the boosters to run at high power consumption levels constantly, leading to more rapid consumption of the charge of the vehicle battery, potentially affecting power supply to other electrical devices in the vehicle at the same time (e.g., vehicle charging, car entertainment facilities). Additionally, these boosters are unable to provide users with battery power warnings, making it difficult for users to be aware of potential battery power risks, leading to poor user experience or dangers during use.

### SUMMARY

In view of the shortcomings of the prior art, a method and system for controlling a vehicle-mounted electrical device and capable of regulating power consumption, protecting a power source, and providing alarms is provided in the present disclosure, which addresses the issues associated with the vehicle-mounted electrical device easily consuming power of a vehicle power source, potentially leading to battery depletion or even damage, and resulting in safety hazards, and provides a function of alarming the user about a charge of the power source of the vehicle.

According to embodiments of the present disclosure, a first solution is provided as follows.

A method for controlling a vehicle-mounted electrical device includes: acquiring, by a detection and control circuit, a real-time voltage of a power source and determining, by the detection and control circuit, a type of the power source through comparing the real-time voltage with a criterion voltage, wherein the detection and control circuit acquires the real-time voltage in a wired manner or in a wireless manner; invoking a charge control range corresponding to the type of the power source, and determining whether an alarm is required and whether to control a power supply to an electrical apparatus based on a relationship between the charge control range and a real-time remaining charge of the power source; when the real-time remaining charge fails to fall within the charge control range, transmitting an alarm information to an alarm circuit, activating the alarm circuit to exhibit to a user that an alarm status is severe, and the real-time remaining charge is outside the charge control range; when the real-time remaining charge falls within the charge control range, controlling at least one of the electrical apparatus, a module, or a component based on a charge determination conclusion, and determining whether to issue an alarm and determining an alarm type based on the charge determination conclusion, wherein when the alarm is required to be issued, the detection and control circuit transmits the alarm information to the alarm circuit, and the alarm circuit is activated.

In an embodiment, the charge control range comprises a first range, a second range, and a third range; the first range allows all electrical apparatuses to operate at full functionality and performance without damage to the power source; the second range allows all electrical apparatuses to operate at full functionality and performance with the real-time remaining charge rapidly entering the third range; the third range is a minimum safe operation range for the power source; the third range has a lower limit, and the lower limit is a minimum value for a safe operation of a vehicle and a minimum value without damage to the power source; when the real-time remaining charge falls within the first range, it is determined that the power source has sufficient charge, and the electrical apparatuses operate at full functionality and performance without the alarm information being issued; when the real-time remaining charge falls within the third range, it is determined that the power source has extremely low charge, a power source circuit activates the alarm circuit to exhibit to the user that the alarm status is extremely low charge, and a safe operation of a vehicle and operations of the detection and control circuit and the alarm circuit are maintained at extremely low power consumption.

In an embodiment, when the real-time remaining charge falls within the second range, it is determined that the power source has insufficient charge; the electrical apparatus enter a low-power consumption mode, based on importance of the electrical apparatus and importance of a functional component of the electrical apparatus, or a prompt whether to enter the low-power consumption mode is issued to the user for a decision whether to enter the low-power consumption mode; when an instruction to not enter the low-power consumption mode is received, the electrical apparatus operates at full functionality and performance, ready for instructions from the user until the real-time remaining charge entering the third range; when an instruction to enter the low-power consumption mode is received, the electrical apparatus operates in the low-power consumption mode; the electrical apparatus is controlled based on a preset priority level of a corresponding electrical apparatus, an electrical apparatus with a higher priority level is preferentially ceased to be supplied power, and an electrical apparatus with a lower priority level continues to operate and is ceased to be supplied power until the real-time remaining charge enters the third range; a device for maintaining the safe operation of the vehicle and a circuit to implement the method are without being assigned priority levels.

In an embodiment, when the real-time remaining charge falls into the second range, a plurality of submodules of the electrical apparatus are individually controlled; the detection and control circuit detects operational status of each submodule circuit of the electrical apparatus and determine emergency and importance level of the each submodule circuit; based on the operational status and the emergency and importance level of a corresponding submodule, whether to turn off the corresponding submodule or enable the corresponding submodule to operate is determined.

In an embodiment, the detection and control circuit adjusts the activation or turnoff of each submodule circuit based on the charge control range into which the real-time voltage falls and the operational status of the each submodule; when the real-time remaining charge falls within the first range, the detection and control circuit enables all submodule circuits to be activated and to operate; when the real-time remaining charge falls within the second range, the detection and control circuit turns off submodule circuits with a low importance level or submodule circuits with poor performance, or the detection and control circuit allows a selection of submodule circuits for activation or turnoff as determined by the user; when the real-time remaining charge falls within the third range, the detection and control circuit actively turns off all circuits; the turnoff is exacted by ceasing to supply power to a corresponding circuit.

In an embodiment, ceasing to supply power is controlled by the power source circuit, and the power source circuit, upon receiving a signal from the detection and control circuit, controls a disconnection of a circuit switch corresponding to the electrical apparatus to be turned off, and a power supply to the electrical apparatus is ceased; and/or the ceasing to supply power is executed by the detection and control circuit, the detection and control circuit is equipped with a comparison circuit for comparing a preset voltage with the real-time voltage, when the real-time voltage is lower than the preset voltage, a power supply to relevant electrical apparatus is ceased.

In an embodiment, the power source circuit is equipped with a power control switch, and the power control switch is configured to control a power supply to the submodule circuit or the electrical apparatus; the power control switch is an electronic switch, a mechanical switch, or an enable switch of an internal element of the submodule circuit.

According to embodiments of the present disclosure, a second solution is provided as follows, based on the method for controlling a vehicle-mounted electrical device in the first solution as described above.

A system for controlling a vehicle-mounted electrical device includes: a power source, supplying electrical energy to an electrical apparatus and a detection and control circuit; a detection and control circuit, configured to detect a real-time voltage of the power source, determine a type of the power source by comparing the real-time voltage with a criterion voltage, invoke a charge control range corresponding to the type of the power source, and, based on a relationship between the charge control range and a real-time remaining charge of the power source, control a power supply status of the electrical apparatus; and an alarm circuit, controlled by the detection and control circuit and issuing an alarm with a corresponding alarm status when activated, wherein the alarm circuit is equipped with a plurality of alarm modes, and is activated under a control of the detection and control circuit, each alarm mode corresponds to an alarm status, and each alarm status corresponds to a charge control range of the power source.

A computer-readable storage medium, storing computer programs, wherein when the computer programs are executed by a processor, the processor is enabled to implement a method for controlling a vehicle-mounted electrical device. The method includes: acquiring, by a detection and control circuit, a real-time voltage of a power source and determining, by the detection and control circuit, a type of the power source through comparing the real-time voltage with a criterion voltage, wherein the detection and control circuit acquires the real-time voltage in a wired manner or in a wireless manner; invoking a charge control range corresponding to the type of the power source, and determining whether an alarm is required and whether to control a power supply to an electrical apparatus based on a relationship between the charge control range and a real-time remaining charge of the power source; when the real-time remaining charge fails to fall within the charge control range, transmitting an alarm information to an alarm circuit, activating the alarm circuit to exhibit to a user that an alarm status is severe, and the real-time remaining charge is outside the charge control range; when the real-time remaining charge falls within the charge control range, controlling at least one of the electrical apparatus, a module, or a component based on a charge determination conclusion, and determining whether to issue an alarm and determining an alarm type based on the charge determination conclusion, wherein when the alarm is required to be issued, the detection and control circuit transmits the alarm information to the alarm circuit, and the alarm circuit is activated.

A computer device, including a memory and a processor, wherein the memory stores computer programs, when the computer programs are executed by the processor, the processor is enabled to implement a method for controlling a vehicle-mounted electrical device. The method includes: acquiring, by a detection and control circuit, a real-time voltage of a power source and determining, by the detection and control circuit, a type of the power source through comparing the real-time voltage with a criterion voltage, wherein the detection and control circuit acquires the real-time voltage in a wired manner or in a wireless manner; invoking a charge control range corresponding to the type of the power source, and determining whether an alarm is required and whether to control a power supply to an electrical apparatus based on a relationship between the charge control range and a real-time remaining charge of the power source; when the real-time remaining charge fails to fall within the charge control range, transmitting an alarm information to an alarm circuit, activating the alarm circuit to exhibit to a user that an alarm status is severe, and the real-time remaining charge is outside the charge control range; when the real-time remaining charge falls within the charge control range, controlling at least one of the electrical apparatus, a module, or a component based on a charge determination conclusion, and determining whether to issue an alarm and determining an alarm type based on the charge determination conclusion, wherein when the alarm is required to be issued, the detection and control circuit transmits the alarm information to the alarm circuit, and the alarm circuit is activated.

Compared with the prior art, the technical solution provided in the present disclosure has the following advantages.

The control method and system in the present disclosure, by adopting intelligent and automated control means, achieve meticulous management of the vehicle-mounted electrical device, enhancing utilization efficiency of a power source and safety of the vehicle, while simultaneously improving user experience. Specifically, the advantages are listed as follows.
1. The power supply status of the electrical apparatus can be intelligently adjusted, by the real-time detection of the voltage of the power source and comparing the detected voltage with the preset criterion voltage, effectively controlling power consumption and extending service life of the power source.
2. Management of the power source charge is graded by setting different charge control ranges, thus preventing over-discharge, minimizing damage to the power source, and extending service life of the power source.
3. The requirement to issue alarms to a user can be intelligently determined based on a charge control range within which a remaining charge falls, timely reminding the user about the charge status to avoid inconvenience or danger due to insufficient charge.
4. A plurality of submodules within the electrical apparatus can be separately controlled to achieve finer power consumption management, ensuring necessary functions are met while reducing unnecessary energy consumption and minimizing product heat generation.
5. The alarm circuit is equipped with a plurality of alarm modes, capable of issuing corresponding alarms based on different charge control ranges and alarm statuses, enhancing user awareness to the charge of the power source and facilitating user response.

### BRIEF DESCRIPTION OF THE DRAWINGS

To more clearly illustrate the technical solutions in the embodiments of the present disclosure or in the prior art, a brief introduction to the drawings used in the description of the embodiments or the prior art is provided below. Obviously, the drawings described below are merely some embodiments of the present disclosure, and for the ordinary skilled person in the art, other drawings can be obtained based on these drawings without creative effort.

FIG. 1 is a flow chart of a method for controlling a vehicle-mounted electrical device and capable of regulating power consumption, protecting a power source, and providing alarms according to an embodiment of the present disclosure.

FIG. 2 is a schematic view of a vehicle-mounted signal booster system capable of detecting a charge of the power source according to an embodiment of the present disclosure.

FIG. 3 is a hardware block diagram of a system for controlling a vehicle-mounted electrical device and capable of detecting the charge of the power source, controlling power consumption, and providing alarms according to an embodiment of the present disclosure.

FIG. 4 is a block diagram of a multi-band vehicle-mounted signal booster capable of detecting the charge of the power source, controlling power consumption, and providing alarms according to an embodiment of the present disclosure.

FIG. 5 is a logic flowchart of detecting the charge of the power source and determining charge control ranges according to an embodiment of the present disclosure.

FIG. 6 is a logic flowchart of controlling power consumption of the vehicle-mounted signal booster based on the charge control range according to an embodiment of the present disclosure.

FIG. 7 is a structural block diagram of a computer device according to an embodiment of the present disclosure.

### DETAILED DESCRIPTION

In order for the ordinary skilled person in the art to better understand the technical solutions in the present disclosure, the technical solutions in the embodiments of the present disclosure will be clearly and completely described below in conjunction with the drawings in the embodiments of the present disclosure. It should be apparent that the described embodiments are merely part of the embodiments of the present disclosure, and not all of the embodiments. All other embodiments obtained by the ordinary skilled person in the art without making creative efforts based on the embodiments in the present disclosure fall within the scope of protection of the present disclosure.

To clearly elaborate the technical solutions of the present disclosure, a vehicle-mounted signal booster is employed as an example of a vehicle-mounted electrical device. Herein, it is elaborately described in detail on how the vehicle-mounted electrical device is controlled and regulated to realize power consumption control and power source protection.

### Embodiment I

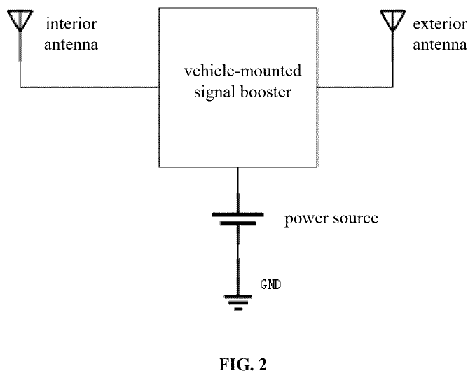

FIG. 2 illustrates a vehicle-mounted signal booster system capable of detecting a charge of the power source.

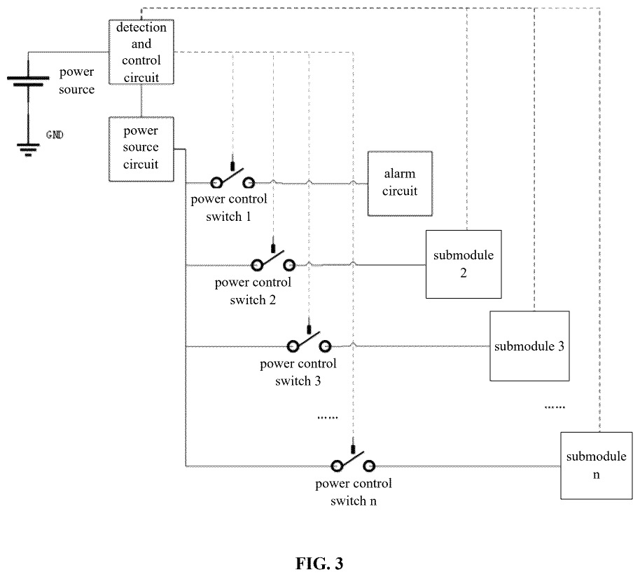

FIG. 3 depicts a hardware block diagram of a system for controlling a vehicle-mounted electrical device and capable of detecting the charge of the power source, controlling power consumption, and providing alarms.

The vehicle-mounted signal booster is connected to a vehicle battery or a vehicle charger port (a voltage of which typically represents a voltage of the vehicle battery) via a power cable or other conductive wires. A host detects the voltage of the vehicle battery and determines whether the vehicle battery is a 12V battery, 24V battery, 36V battery, or other type. Ranges for sufficient charge, slightly low charge, and extremely low charge corresponding to the type of the vehicle battery are determined. Subsequently, power consumption of the vehicle-mounted signal booster is adjusted based on different charge control ranges of the vehicle battery. When the battery charge is sufficient, the vehicle-mounted signal booster operates at full functionality and performance. When the battery charge is slightly low, some circuits of lower importance of the vehicle-mounted signal booster are turned off, or an alarm is issued to a user, allowing the user to choose which circuits to be turned off. When the battery charge is extremely low, a majority of circuits of the vehicle-mounted signal booster are turned off or the entire vehicle-mounted signal booster is completely turned off, simultaneously alarming the user.

In the present disclosure, a system for controlling a vehicle-mounted electrical device and capable of regulating power consumption, protecting a power source, and providing alarms. The system includes a power source, a detection and control circuit, and an alarm circuit.

The power source supplies electrical energy to an electrical apparatus and the detection and control circuit. The power source may be a battery or other power source.

The detection and control circuit is configured to detect a real-time voltage of the power source, determine a type of the power source by comparing the real-time voltage with a stored criterion voltage, invoke a charge control range corresponding to the determined type of the power source, and, based on a relationship between the charge control range and a real-time remaining charge of the power source, control a power supply status of the electrical apparatus.

The alarm circuit is controlled by the detection and control circuit, and may issue an alarm with a corresponding alarm status when activated. The alarm circuit is equipped with a plurality of alarm modes, and is activated under a control of the detection and control circuit. Different alarm modes correspond to different alarm statuses, and different alarm statuses correspond to different charge control ranges of the power source.

### Embodiment II

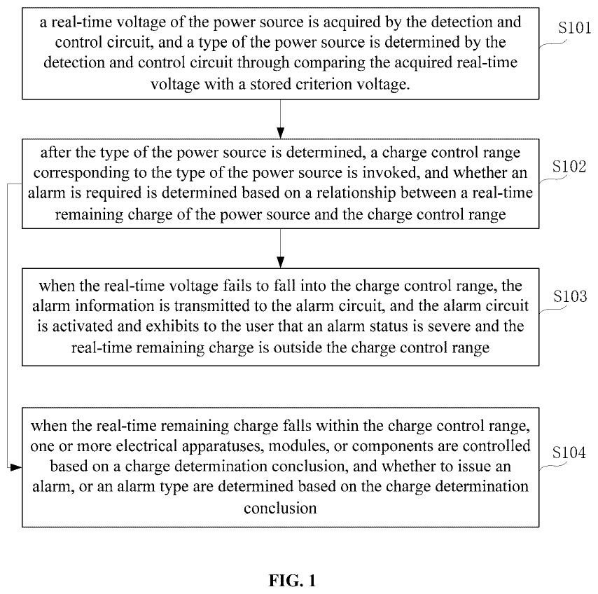

FIG. 1 is a flow chart of a method for controlling a vehicle-mounted electrical device and capable of regulating power consumption, protecting a power source, and providing alarms.

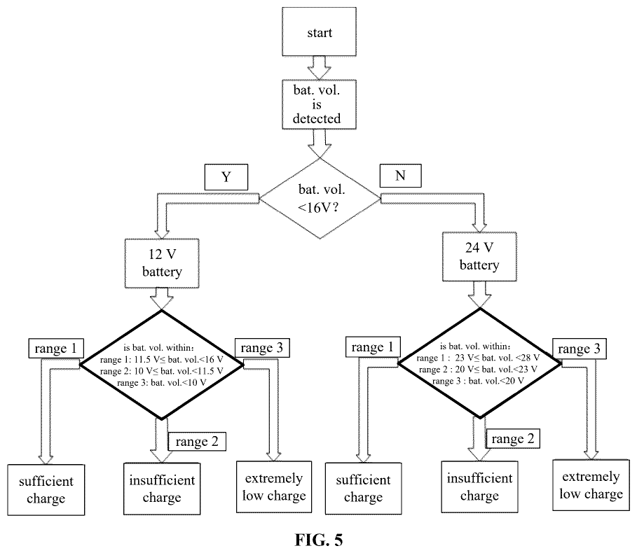

FIG. 5 is a logic flowchart of detecting the charge of the power source and determining the charge control ranges.

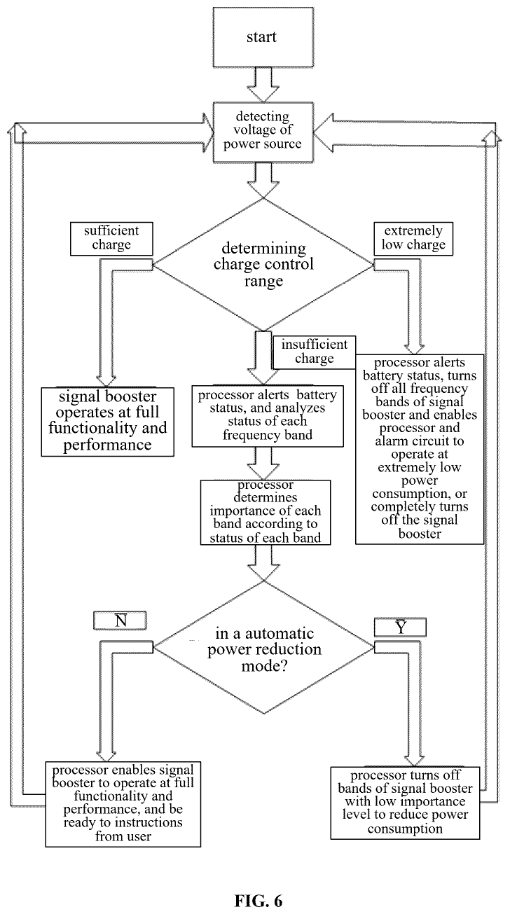

FIG. 6 is a logic flowchart of controlling power consumption of the vehicle-mounted signal booster based on the charge control ranges.

In this embodiment, a method for controlling a vehicle-mounted electrical device and capable of regulating power consumption, protecting a power source, and providing alarms is provided. The method includes the following operations of S101 to S104.

In an operation S101, a real-time voltage of the power source is acquired by the detection and control circuit, and a type of the power source is determined by the detection and control circuit through comparing the acquired real-time voltage with a stored criterion voltage.

The detection and control circuit may acquire the real-time voltage of the power source in a wired manner (e.g., via wires or power cables) or in a wireless manner (e.g., using a Bluetooth module to detect the real-time voltage and communicate to the detection and control circuit). Further, the detection and control circuit analyzes the type of the power source corresponding to the real-time voltage.

Specifically, the type of power source, such as a 12V battery, a 24V battery, or a 36V battery, may be used to define a voltage range of the power source.

A real-time voltage greater than 28V corresponds to the 36V battery, and a real-time voltage less than 16V corresponds to the 12V battery. A specific criterion voltage may be set according to actual conditions. Since the 12V battery and the 24V battery are most commonly adopted, a determination of whether the real-time voltage is less than 16V may be only required.

In an operation S102, after the type of the power source is determined, a charge control range corresponding to the type of the power source is invoked, and whether an alarm is required is determined based on a relationship between a real-time remaining charge of the power source and the charge control range. When the alarm is required, a corresponding alarm information is transmitted to the alarm circuit.

The real-time remaining charge can be determined based on the real-time voltage or calculated by assessing remaining energy after charging and discharging the power source.

After the type of power source is determined, the charge control range corresponding to the type is invoked. The charge control range may be defined on a basis of a voltage range of the power source. The charge control range includes a first range, a second range, and a third range.

In an operation S103, when the real-time voltage fails to fall into the charge control range, the alarm information is transmitted to the alarm circuit, and the alarm circuit is activated and exhibits to the user that an alarm status is severe and the real-time remaining charge is outside the charge control range.

Taking the real-time voltage as a basis for setting the charge control range corresponding to the real-time remaining charge offers advantages of convenient data collection, low equipment cost, and ease of implementation. Moreover, since mankind has already had a great deal of experience in counting and using the remaining charge based on the voltage, and accuracy can meet practical needs. In addition, the voltage itself is acritical design or performance parameter for the power source and the electrical apparatus.

Taking a 12 V battery as an example of the power source, the first range satisfies: 11.5 V≤a battery voltage<16 V, the second range satisfies: 10 V≤the battery voltage<11.5 V, and the third range satisfies: the battery voltage<10 V.

It should be understood that a lower limit may also be set for the third range. For instance, the third range may satisfy: 8.5 V≤the battery voltage<10 V;

In an operation S104, when the real-time remaining charge falls within the charge control range, one or more electrical apparatuses, modules, or components are controlled based on a charge determination conclusion, and whether to issue an alarm, or an alarm type are determined based on the charge determination conclusion.

When the real-time remaining charge falls within the first range, all electrical apparatuses may operate at full functionality and performance without any damage to the power source.

When the real-time remaining charge falls within the second range, in a case where all electrical apparatuses operate at full functionality and performance, the real-time remaining charge may rapidly enter the third range.

The third range represents the minimum safe operation range for the power source. When the real-time remaining power falls below the lower limit of the third range, damage to the power source or failure to support the safe operation of the vehicle may occur.

The lower limit of the third range is the minimum value for ensuring essential safe operation of the vehicle and the minimum value for preventing damage to the power source.

When the real-time remaining charge of the power source falls below the lower limit of the third range, the vehicle may fail to start, or experience sudden power outages, or essential safety equipment may fail to operate. When the real-time remaining charge remains below the lower limit of the third range for a long period of time, the life of the power source may be affected, potentially leading to power source failure, leakage, or even explosion.

For instance, when the battery voltage is less than 8.5V, the alarm circuit issues an alarm that the battery voltage is about to enter a hazardous operation range of the power source. In this condition, recharging the battery or stopping the vehicle for maintenance is strongly recommended.

When the real-time remaining charge falls within the first range, it is determined that the power source has sufficient charge, and the electrical apparatuses may operate at full functionality and performance without alarm information being issued.

When the real-time remaining charge falls within the third range, it is determined that the power source has extremely low charge, a power source circuit activates the alarm circuit to exhibit to the user that the alarm status is extremely low charge, and safe operation of the vehicle and the operations of the detection and control circuit and the alarm circuit are maintained at extremely low power consumption.

All other electrical apparatuses, apart from electrical apparatuses for maintaining the safe operation of the vehicle, the detection and control circuit, and the alarm circuit, are ceased to be supplied power to reduce power consumption and prolong a safe operation time of the vehicle. Furthermore, an alarm of extremely low charge is issued through the alarm circuit to prompt the user to recharge the power source or perform maintenance as soon as possible.

Equipment for maintaining the safe operation of the vehicle includes, but is not limited to, an electric ignition device of an engine, devices for monitoring vehicle operation status (such as monitoring tire pressure, monitoring fuel level, and the like), and screens for displaying the vehicle operation status.

Other electrical apparatuses include, but are not limited to, an air conditioner, a seat electrical heater, a music player, a vehicle signal booster, and so on.

When the real-time remaining charge falls within the second range, it is determined that the power source has insufficient charge, and the electrical apparatuses enter a low-power consumption mode, according to importance of the electrical apparatuses and importance of functional components of the electrical apparatuses.

Alternatively, a prompt whether to enter the low-power consumption mode may be issued to the user, and a decision whether to enter the low-power consumption mode may be made by the user.

When an instruction to not enter the low-power consumption mode is received, the electrical apparatuses operate at full functionality and performance, ready for control instructions from the user until the real-time remaining charge entering the third range.

When an instruction to enter into the low-power consumption mode is received, the electrical apparatuses operate in the low-power consumption mode.

The electrical apparatuses are controlled based on a preset priority level of the electrical apparatuses. An electrical apparatus with a higher priority level is preferentially ceased to be supplied power, and an electrical apparatus with a lower priority level continues to operate and is ceased to be supplied power until the real-time remaining charge enters the third range.

The priority level refers to a priority level for being ceased to be supplied power. A higher priority level indicates lower importance and thus the electrical apparatus with the higher priority level is preferentially ceased to be supplied power. A lower priority level indicates higher importance and thus the electrical apparatus with the lower priority level is ceased to be supplied power relatively late.

Electrical apparatuses essential for maintaining the safe operation of the vehicle and circuits to implement the above control method are not assigned priority levels, as these devices are required to ensure stable operation of the power source.

Circuits for implementing the aforementioned control method include the detection and control circuit, the alarm circuit, and corresponding switches.

The detection and control circuit may include the power source circuit.

It should also be noted that the user can determine which electrical apparatus to be turned off and which electrical apparatus to keep operating.

The ceasing to supply power can be controlled by the power source circuit. The power source circuit, upon receiving a signal from the detection and control circuit, controls the disconnection of circuit switches corresponding to the electrical apparatuses to be turned off, thus disconnecting the electrical apparatuses from the power source.

The ceasing to supply power can be executed by the detection and control circuit. The detection and control circuit is equipped with a comparison circuit for comparing a preset voltage with the real-time voltage. When the real-time voltage is lower than the preset voltage, the power supply to relevant electrical apparatus is ceased.

It should be noted that the detection and control circuit is typically a microprocessor (MCU, an example model: STM32 single-chip microcontroller) with detection, storage, algorithm, and a control function or a chip, chipset, circuit, or module with similar functions.

In certain scenarios, operations of the detection and control circuit can be implemented using a discrete component without storage and algorithm. For example, the power source voltage can be input into a group or a plurality of groups of operational amplifier comparators, each group of operational amplifier comparators is set with a different comparison voltage related to corresponding voltage of the power source charge. For instance, a voltage of a 12V battery below 10V is determined to be in the “extremely low charge range”. When a comparator is set with a “negative input end” reference voltage of 10V and a “positive input end” voltage below 10V, the comparator outputs a “low voltage”. Based on the output voltage of the comparator, the power supply to a corresponding module can be ceased and alarms can be issued.

For other charge ranges, the detection and control can also be implemented by different comparators and setting different reference voltages. Through discrete circuits, various logical control effects can be achieved for detecting and controlling voltages of different types of power source. The above solution is only an example and will not be over described.

### Embodiment III

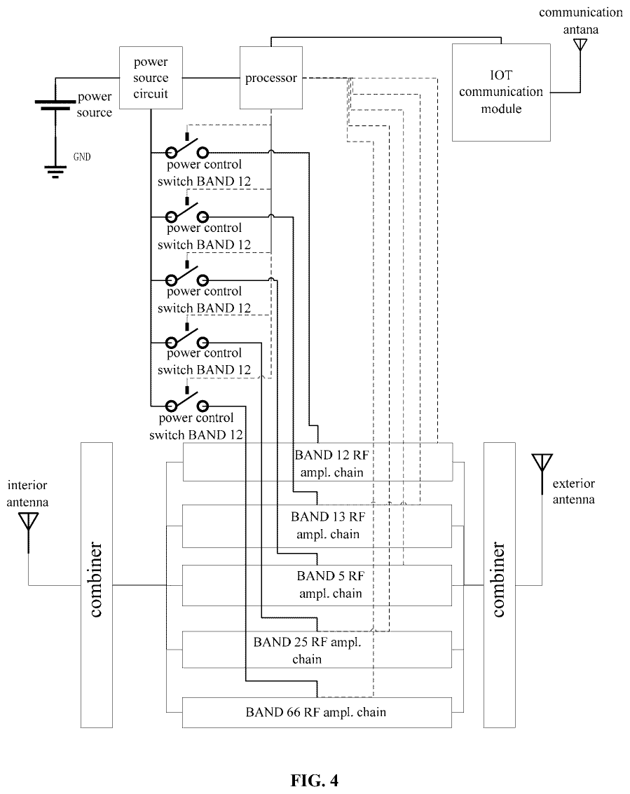

FIG. 4 is a block diagram of a multi-band vehicle-mounted signal booster capable of detecting the charge of the power source, controlling power consumption, and providing alarms.

When the remaining charge falls into the second range, in addition that the electrical apparatus may be turned off, a plurality of operational submodules of the electrical apparatus can be individually controlled to reduce power consumption while ensuring necessary functionalities of the electrical apparatuses.

The detection and control circuit can also detect operational status of each submodule circuit of the electrical apparatus and determine emergency and importance level of the each submodule circuit. Based on the operational status and the emergency and importance level of a corresponding submodule, whether to turn off the corresponding submodule or enable the corresponding submodule to operate is determined.

For instance, a vehicle-mounted cellphone signal booster operates under a predefined mechanism as follows. The vehicle-mounted cellphone signal booster typically corresponds to five frequency bands (BAND12, BAND13, BAND5, BAND25, and BAND66), and each frequency band of the five frequency bands corresponds to a group of RF amplification chains, with each group of RF amplification chains considered as a submodule circuit. When a downlink signal of a certain frequency band is detected to be very weak, it can be deemed that the signal for this frequency band is very weak.

A rule for determining that a weak downlink signal is that it is typically determined as very weak when the downlink output signal strength approaches a downlink output noise floor.

In vehicular scenarios, while the vehicle is in motion, it often encounters situations where certain frequency bands have no signal. Therefore, a group of RF amplification chains corresponding to the certain frequency bands can be turned off when necessary to reduce the power consumption of the vehicle-mounted signal booster. A specific determination method is relevant to a product form, and different products or application scenarios corresponds different determination methods, which will not be over described here.

The detection and control circuit adjusts the activation or turnoff of each submodule circuit based on the charge control range into which the real-time voltage falls and the operational status of the each submodule.

When the detected charge range is a range for sufficient charge, i.e., when the real-time remaining charge falls within the first range, the detection and control circuit enables all or a majority of submodule circuits to be activated and to operate.

When the detected charge range is a range for insufficient charge, i.e., when the real-time remaining charge falls within the second range, the detection and control circuit turns off some unimportant submodule circuits or some submodule circuits with poor performance. The detection and control circuit can also transfer control to the user, allowing a selection of submodule circuits for activation or turnoff as determined by the user.

When the detected charge range is a range for extremely low charge, and there is a risk of damage to the power source, i.e., when the real-time remaining charge falls within the third range, the detection and control circuit actively turns off a majority of or even all circuits to protect the power source.

Similarly, the power supply control for submodules can also be achieved by the detection and control circuit or by discrete components without storage and algorithm within the detection and control circuit, which will not be over described here.

### Clarification of Submodule Circuits

In a vehicle-mounted signal booster, submodule circuits typically refer to RF amplification chains for different frequency bands or a portion of circuits of the RF amplification chains. It is not usually necessary for all RF amplification chains to operate simultaneously. Thus in certain scenarios, some RF amplification chains or a portion of circuits of the RF amplification chains can be turned off.

In other vehicular electrical products, a similar approach can be applied, with dividing internal circuits of the electrical products into submodules, assessing importance levels of the corresponding submodules, and making adjustments based on different battery charge.

### Explanation of the Alarm Circuit

The alarm circuit transmits alarm information to the user via Bluetooth, indicators, buzzers, etc., using audio, visual, or electrical methods. Typically, different alarm methods correspond to different alarm levels. For instance, when the battery charge is sufficient, the battery information is usually discovered by the user through an active check (such as through an indicator light or by actively querying messages sent by the system to a mobile app). Whereas, when the battery charge is insufficient, the system employs more apparent alarm methods (such as blinking of the indicator light of the vehicle-mounted signal booster, buzzing from buzzers, and pushing alarm information via Bluetooth to a mobile phone with notifications) to notify the user, making it easier for the user to detect abnormalities of the power source of the vehicle.

### Explanation of the Power Control Switch

The power control switch is used to turn off the submodule circuits or the electrical apparatuses. The power control switch may be an electronic switch (such as MOS triode, crystal triode, integrated circuit switch, etc.) or a mechanical switch (e.g., mechanical relay, toggle switch, push button switch, etc.), or enable switch of a component within a submodule circuit. These switches are typically controlled by the detection and control circuit to simplify the circuit, simplify operation, and reduce cost. In some situations, these switches can also be manually operated by the user for control, although this method is generally more complex and more expensive.

It should be noted as a supplementary explanation that, the charge control range can be set more finely, and the determination of the real-time remaining charge can also be more precise, although this will usually increase circuit complexity.

A coulomb counter or other charge statistics circuit can be used to measure a charge consumption of the power source. This method typically requires the detection and control circuit to be directly connected in series with a positive electrode or a negative electrode of the power source of the vehicle to accurately track the actual charge of the power source. In this way, a more accurate estimation to the charge of the power source can be achieved.

By measuring a difference between a charged energy into the power source and a discharged energy of the power source, further based on an adjustment value for power source loss, a relatively precise remaining charge can be obtained, facilitating further precise protection to the power source.

In this method, the remaining charge can be set as the basis for determining the power control ranges. The first range may be 100%-60% of a rated capacity of the power source, the second range may be 60%-40% of a rated capacity of the power source, and the third range may be 40%-20% of a rated capacity of the power source.

If a larger safety range for power usage is adopted, the third range can be set to 40%-10% of the rated capacity of the power source.

A setting of specific values of the ranges can be determined based on the need, standards for safe power consumption, and actual usage requirements.

### Embodiment IV

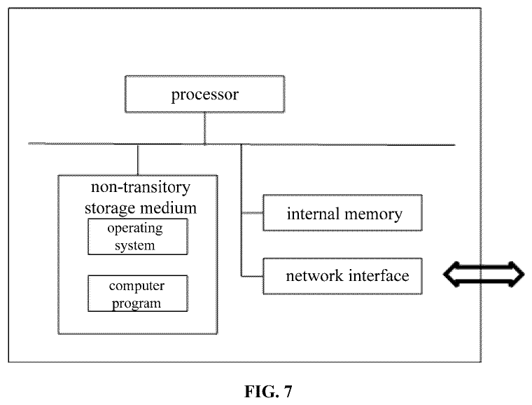

FIG. 7 is a block diagram of internal structure of a computer device according to an embodiment of the present disclosure. Specifically, the computer device can be a terminal or a server. As shown in FIG. 7, the computer device includes a processor, a memory, and a network interface connected together via a system bus. The memory includes a non-transitory storage medium and internal memory. The non-transitory storage medium of the computer device stores an operating system and may also store computer programs. When the computer programs are executed by the processor, the processor is enabled to implement the method for controlling a vehicle-mounted electrical device and capable of regulating power consumption, protecting a power source, and providing alarms. The internal memory may also store computer programs, and when the computer programs are executed by the processor, the processor is enabled to implement the method for controlling a vehicle-mounted electrical device and capable of regulating power consumption, protecting a power source, and providing alarms. Those skilled in the art can understand that the structure shown in FIG. 7 is merely a block diagram of a part of the structure related to the solution of the present disclosure, and does not constitute a limitation on the computer device to which the solution of the present disclosure is applied. The specific computer device may include more or fewer components than shown in the figure, or have a combine of certain components, or have different component configurations.

In an embodiment, a computer device is provided. The computer device includes a memory and a processor. The memory stores computer programs. When the computer programs are executed by the processor, the processor is enabled to implement a method for controlling a vehicle-mounted electrical device.

The method includes: acquiring, by a detection and control circuit, a real-time voltage of a power source and determining, by the detection and control circuit, a type of the power source through comparing the real-time voltage with a criterion voltage, wherein the detection and control circuit acquires the real-time voltage in a wired manner or in a wireless manner; invoking a charge control range corresponding to the type of the power source, and determining whether an alarm is required and whether to control a power supply to an electrical apparatus based on a relationship between the charge control range and a real-time remaining charge of the power source; when the real-time remaining charge fails to fall within the charge control range, transmitting an alarm information to an alarm circuit, activating the alarm circuit to exhibit to a user that an alarm status is severe, and the real-time remaining charge is outside the charge control range; when the real-time remaining charge falls within the charge control range, controlling at least one of the electrical apparatus, a module, or a component based on a charge determination conclusion, and determining whether to issue an alarm and determining an alarm type based on the charge determination conclusion, wherein when the alarm is required to be issued, the detection and control circuit transmits the alarm information to the alarm circuit, and the alarm circuit is activated.

In an embodiment, a computer-readable storage medium is provided, storing computer programs. When the computer programs are executed by a processor, the processor is enabled to implement a method for controlling a vehicle-mounted electrical device.

The method includes: acquiring, by a detection and control circuit, a real-time voltage of a power source and determining, by the detection and control circuit, a type of the power source through comparing the real-time voltage with a criterion voltage, wherein the detection and control circuit acquires the real-time voltage in a wired manner or in a wireless manner; invoking a charge control range corresponding to the type of the power source, and determining whether an alarm is required and whether to control a power supply to an electrical apparatus based on a relationship between the charge control range and a real-time remaining charge of the power source; when the real-time remaining charge fails to fall within the charge control range, transmitting an alarm information to an alarm circuit, activating the alarm circuit to exhibit to a user that an alarm status is severe, and the real-time remaining charge is outside the charge control range; when the real-time remaining charge falls within the charge control range, controlling at least one of the electrical apparatus, a module, or a component based on a charge determination conclusion, and determining whether to issue an alarm and determining an alarm type based on the charge determination conclusion, wherein when the alarm is required to be issued, the detection and control circuit transmits the alarm information to the alarm circuit, and the alarm circuit is activated.

Those skilled in the art can understand that the entire or part of the processes of the methods in the above-mentioned embodiment can be implemented by computer programs instructing relevant hardware. The program can be stored in a non-transitory computer-readable storage medium. When the programs are executed, the processes embodiments of the various methods as mentioned above can be implemented. Any memories, storages, databases, or other media in the various embodiments provided by the present disclosure may include non-transitory and/or transitory memories. Particularly, the non-transitory memory may include Read-Only Memory (ROM), Programmable ROM (PROM), Electrically Programmable ROM (EPROM), Electrically Erasable Programmable ROM (EEPROM), or flash memory. Transitory memory may include Random Access Memory (RAM) or external high-speed buffer memory. As an illustration rather than a limitation, RAM is available in many forms, such as Static RAM (SRAM), Dynamic RAM (DRAM), Synchronous DRAM (SDRAM), Double Data Rate SDRAM (DDRSDRAM), Enhanced SDRAM (ESDRAM), Synchronous Link (Synchlink) DRAM (SLDRAM), Rambus Direct RAM (RDRAM), Direct Rambus Dynamic RAM (DRDRAM), and Rambus Dynamic RAM (RDRAM) etc.

The various technical features of the above embodiments can be combined in an arbitrary manner. For the sake of brevity, not all possible combinations of the technical features in the above embodiments have been described. However, as long as the combinations of these technical features do not exist in contradiction, they should be considered within the scope recorded in this specification.

The embodiments described above only express several implementation modes of the present disclosure, and their descriptions are relatively specific and detailed, but they should not be therefore understood as limitations to the scope of the patent of the present disclosure. It should be noted that, for those skilled in the art, without departing from the concept of the present disclosure, modifications and improvements can still be made, which all belong to the protection scope of the present disclosure. Therefore, the protection scope of the present disclosure should be subject to the appended claims.

What is claimed is:

1. A method for controlling a vehicle-mounted electrical device, comprising:
acquiring, by a detection and control circuit, a real-time voltage of a power source and determining, by the detection and control circuit, a type of the power source through comparing the real-time voltage with a criterion voltage, wherein the detection and control circuit acquires the real-time voltage in a wired manner or in a wireless manner;
invoking a charge control range corresponding to the type of the power source, and determining whether an alarm is required and whether to control a power supply to an electrical apparatus based on a relationship between the charge control range and a real-time remaining charge of the power source;
when the real-time remaining charge fails to fall within the charge control range, transmitting an alarm information to an alarm circuit, activating the alarm circuit to exhibit to a user that an alarm status is severe, and the real-time remaining charge is outside the charge control range;
when the real-time remaining charge falls within the charge control range, controlling at least one of the electrical apparatus, a module, or a component based on a charge determination conclusion, and determining whether to issue an alarm and determining an alarm type based on the charge determination conclusion, wherein when the alarm is required to be issued, the detection and control circuit transmits the alarm information to the alarm circuit, and the alarm circuit is activated.

2. The method for controlling a vehicle-mounted electrical device as claimed in claim 1, wherein the charge control range comprises a first range, a second range, and a third range;
the first range allows all electrical apparatuses to operate at full functionality and performance without damage to the power source;
the second range allows all electrical apparatuses to operate at full functionality and performance with the real-time remaining charge rapidly entering the third range;
the third range is a minimum safe operation range for the power source;
the third range has a lower limit, and the lower limit is a minimum value for a safe operation of a vehicle and a minimum value without damage to the power source;
when the real-time remaining charge falls within the first range, it is determined that the power source has sufficient charge, and the electrical apparatuses operate at full functionality and performance without the alarm information being issued;
when the real-time remaining charge falls within the third range, it is determined that the power source has extremely low charge, a power source circuit activates the alarm circuit to exhibit to the user that the alarm status is extremely low charge, and a safe operation of a vehicle and operations of the detection and control circuit and the alarm circuit are maintained at extremely low power consumption.

3. The method for controlling a vehicle-mounted electrical device as claimed in claim 2, wherein when the real-time remaining charge falls within the second range, it is determined that the power source has insufficient charge;
the electrical apparatus enter a low-power consumption mode, based on importance of the electrical apparatus and importance of a functional component of the electrical apparatus, or a prompt whether to enter the low-power consumption mode is issued to the user for a decision whether to enter the low-power consumption mode;
when an instruction to not enter the low-power consumption mode is received, the electrical apparatus operates at full functionality and performance, ready for instructions from the user until the real-time remaining charge entering the third range;
when an instruction to enter the low-power consumption mode is received, the electrical apparatus operates in the low-power consumption mode;
the electrical apparatus is controlled based on a preset priority level of a corresponding electrical apparatus, an electrical apparatus with a higher priority level is preferentially ceased to be supplied power, and an electrical apparatus with a lower priority level continues to operate and is ceased to be supplied power until the real-time remaining charge enters the third range;
a device for maintaining the safe operation of the vehicle and a circuit to implement the method are without being assigned priority levels.

4. The method for controlling a vehicle-mounted electrical device as claimed in claim 2, wherein when the real-time remaining charge falls into the second range, a plurality of submodules of the electrical apparatus are individually controlled;
the detection and control circuit detects operational status of each submodule circuit of the electrical apparatus and determine emergency and importance level of the each submodule circuit; based on the operational status and the emergency and importance level of a corresponding submodule, whether to turn off the corresponding submodule or enable the corresponding submodule to operate is determined.

5. The method for controlling a vehicle-mounted electrical device as claimed in claim 4, wherein the detection and control circuit adjusts the activation or turnoff of each submodule circuit based on the charge control range into which the real-time voltage falls and the operational status of the each submodule;
when the real-time remaining charge falls within the first range, the detection and control circuit enables all submodule circuits to be activated and to operate;
when the real-time remaining charge falls within the second range, the detection and control circuit turns off submodule circuits with a low importance level or submodule circuits with poor performance, or the detection and control circuit allows a selection of submodule circuits for activation or turnoff as determined by the user;
when the real-time remaining charge falls within the third range, the detection and control circuit actively turns off all circuits;
the turnoff is exacted by ceasing to supply power to a corresponding circuit.

6. The method for controlling a vehicle-mounted electrical device as claimed in claim 3, wherein ceasing to supply power is controlled by the power source circuit, and the power source circuit, upon receiving a signal from the detection and control circuit, controls a disconnection of a circuit switch corresponding to the electrical apparatus to be turned off, and a power supply to the electrical apparatus is ceased; and/or
the ceasing to supply power is executed by the detection and control circuit, the detection and control circuit is equipped with a comparison circuit for comparing a preset voltage with the real-time voltage, when the real-time voltage is lower than the preset voltage, a power supply to relevant electrical apparatus is ceased.

7. The method for controlling a vehicle-mounted electrical device as claimed in claim 6, wherein the power source circuit is equipped with a power control switch, and the power control switch is configured to control a power supply to the submodule circuit or the electrical apparatus;
the power control switch is an electronic switch, a mechanical switch, or an enable switch of an internal element of the submodule circuit.

8. A system for controlling a vehicle-mounted electrical device, comprising:
a power source, supplying electrical energy to an electrical apparatus and a detection and control circuit;
a detection and control circuit, configured to detect a real-time voltage of the power source, determine a type of the power source by comparing the real-time voltage with a criterion voltage, invoke a charge control range corresponding to the type of the power source, and, based on a relationship between the charge control range and a real-time remaining charge of the power source, control a power supply status of the electrical apparatus; and
an alarm circuit, controlled by the detection and control circuit and issuing an alarm with a corresponding alarm status when activated, wherein the alarm circuit is equipped with a plurality of alarm modes, and is activated under a control of the detection and control circuit, each alarm mode corresponds to an alarm status, and each alarm status corresponds to a charge control range of the power source.

9. A computer device, comprising a memory and a processor, wherein the memory stores computer programs, when the computer programs are executed by the processor, the processor is enabled to implement a method for controlling a vehicle-mounted electrical device, the method comprising:
acquiring, by a detection and control circuit, a real-time voltage of a power source and determining, by the detection and control circuit, a type of the power source through comparing the real-time voltage with a criterion voltage, wherein the detection and control circuit acquires the real-time voltage in a wired manner or in a wireless manner;
invoking a charge control range corresponding to the type of the power source, and determining whether an alarm is required and whether to control a power supply to an electrical apparatus based on a relationship between the charge control range and a real-time remaining charge of the power source;
when the real-time remaining charge fails to fall within the charge control range, transmitting an alarm information to an alarm circuit, activating the alarm circuit to exhibit to a user that an alarm status is severe, and the real-time remaining charge is outside the charge control range;
when the real-time remaining charge falls within the charge control range, controlling at least one of the electrical apparatus, a module, or a component based on a charge determination conclusion, and determining whether to issue an alarm and determining an alarm type based on the charge determination conclusion, wherein when the alarm is required to be issued, the detection and control circuit transmits the alarm information to the alarm circuit, and the alarm circuit is activated.

10. The computer device as claimed in claim 9, wherein the charge control range comprises a first range, a second range, and a third range;
the first range allows all electrical apparatuses to operate at full functionality and performance without damage to the power source;
the second range allows all electrical apparatuses to operate at full functionality and performance with the real-time remaining charge rapidly entering the third range;
the third range is a minimum safe operation range for the power source;
the third range has a lower limit, and the lower limit is a minimum value for a safe operation of a vehicle and a minimum value without damage to the power source;
when the real-time remaining charge falls within the first range, it is determined that the power source has sufficient charge, and the electrical apparatuses operate at full functionality and performance without the alarm information being issued;
when the real-time remaining charge falls within the third range, it is determined that the power source has extremely low charge, a power source circuit activates the alarm circuit to exhibit to the user that the alarm status is extremely low charge, and a safe operation of a vehicle and operations of the detection and control circuit and the alarm circuit are maintained at extremely low power consumption.

11. The computer device as claimed in claim 10, wherein when the real-time remaining charge falls within the second range, it is determined that the power source has insufficient charge;
the electrical apparatus enter a low-power consumption mode, based on importance of the electrical apparatus and importance of a functional component of the electrical apparatus, or a prompt whether to enter the low-power consumption mode is issued to the user for a decision whether to enter the low-power consumption mode;
when an instruction to not enter the low-power consumption mode is received, the electrical apparatus operates at full functionality and performance, ready for instructions from the user until the real-time remaining charge entering the third range;
when an instruction to enter the low-power consumption mode is received, the electrical apparatus operates in the low-power consumption mode;
the electrical apparatus is controlled based on a preset priority level of a corresponding electrical apparatus, an electrical apparatus with a higher priority level is preferentially ceased to be supplied power, and an electrical apparatus with a lower priority level continues to operate and is ceased to be supplied power until the real-time remaining charge enters the third range;
a device for maintaining the safe operation of the vehicle and a circuit to implement the method are without being assigned priority levels.

12. The computer device as claimed in claim 10, wherein when the real-time remaining charge falls into the second range, a plurality of submodules of the electrical apparatus are individually controlled;
the detection and control circuit detects operational status of each submodule circuit of the electrical apparatus and determine emergency and importance level of the each submodule circuit; based on the operational status and the emergency and importance level of a corresponding submodule, whether to turn off the corresponding submodule or enable the corresponding submodule to operate is determined.

13. The computer device as claimed in claim 12, wherein the detection and control circuit adjusts the activation or turnoff of each submodule circuit based on the charge control range into which the real-time voltage falls and the operational status of the each submodule;
when the real-time remaining charge falls within the first range, the detection and control circuit enables all submodule circuits to be activated and to operate;
when the real-time remaining charge falls within the second range, the detection and control circuit turns off submodule circuits with a low importance level or submodule circuits with poor performance, or the detection and control circuit allows a selection of submodule circuits for activation or turnoff as determined by the user;
when the real-time remaining charge falls within the third range, the detection and control circuit actively turns off all circuits;
the turnoff is exacted by ceasing to supply power to a corresponding circuit.

14. The computer device as claimed in claim 11, wherein ceasing to supply power is controlled by the power source circuit, and the power source circuit, upon receiving a signal from the detection and control circuit, controls a disconnection of a circuit switch corresponding to the electrical apparatus to be turned off, and a power supply to the electrical apparatus is ceased; and/or
the ceasing to supply power is executed by the detection and control circuit, the detection and control circuit is equipped with a comparison circuit for comparing a preset voltage with the real-time voltage, when the real-time voltage is lower than the preset voltage, a power supply to relevant electrical apparatus is ceased.

15. The computer device as claimed in claim 14, wherein the power source circuit is equipped with a power control switch, and the power control switch is configured to control a power supply to the submodule circuit or the electrical apparatus;
the power control switch is an electronic switch, a mechanical switch, or an enable switch of an internal element of the submodule circuit.
